(19) United States
(12) Patent Application Publication
(10) Pub. No.: US 2011/0186597 A1
(43) Pub. Date: Aug. 4, 2011

(54) Baby food spoon

(76) Inventor: Thomas Schaefer, Wildomar, CA (US)

(21) Appl. No.: 12/931,455

(22) Filed: Jan. 31, 2011

Related U.S. Application Data
(60) Provisional application No. 61/337,074, filed on Jan. 29, 2010.

(51) Int. Cl. B65D 35/00; B67D 7/06

(52) U.S. Cl. 222/106; 222/192; 30/124

(57) ABSTRACT

The present invention provides a baby food container and a handy spoon, both combined into one convenient unit. The food container itself basically resembles a tube of toothpaste, featuring a malleable plastic material. The food contained within the unit is of the standard baby food variety. Featuring a safety seal beneath the lid, the threaded opening serves as the attaching point of the provided spoon, a soft plastic utensil with a distinct oval shape. Additionally, a protective cap is provided to enclose the Baby Food Spoon system between uses. Simple in design yet effective in application, one need only choose a container of food, remove the safety seal, and twist on the spoon attachment. Squeezing the food container, the user is able to dispense desired amounts of food into the spoon, and feed the waiting baby.

### CLAIM OF PRIORITY

This patent application claims priority under 35 USC 119 (e) (1) from U.S. Provisional Patent Application Ser. No. 61/337,074 filed Jan. 29, 2010, of common inventorship herewith entitled, “Baby Food Spoon.”

### FIELD OF THE INVENTION

The present invention pertains to the field of eating utensil devices, and more specifically to the field of baby food storage and eating devices.

### BACKGROUND OF THE INVENTION

The prior art has put forth several designs for baby food storage and feeding devices. Among these are:

U.S. Pat. No. 5,305,928 to Roberto Verdaguer describes a container which includes an applicator structure, preferably in the form of a spoon secured to the open end of the container in which food is stored. Squeezing and/or tilting of the container allows food to pass through the interior of the spoon and be delivered to an infant's mouth. A valve structure is disposed in flow-regulating relation between the food within the container and the applicator spoon. The valve may be moved between an open and closed position to prevent spillage and/or selectively allow food to pass onto the spoon when feeding of the infant is desired.

U.S. Pat. No. 5,462,101 to Silva Mouchmouchian describes a system which includes a coupler which attaches to both a baby food jar and a squeezable baby bottle so that the baby food jar can be inverted on the squeezable bottle to gravitationally transfer the baby food without spilling. Thereafter, a nozzle attaches to the coupler or directly to the squeezable baby bottle. The nozzle terminated in a baby feeding spoon. A manual valve is fitted into the nozzle to close it when desired.

U.S. Pat. No. 5,682,931 to Silva Mouchmouchian describes a baby food jar which is directly attachable to the top of a squeezable baby bottle so that the baby food jar can be inverted on the squeezable bottle to gravitationally transfer the baby food without spilling. Thereafter, the feeding member includes a nozzle which attaches directly to the squeezable baby bottle. The nozzle terminates in a baby feeding spoon. Squeezing the bottle delivers baby food directly to the spoon.

None of these prior art references describe the present invention.

### SUMMARY OF THE INVENTION

It is an object of the present invention to provide a design improvement for a baby food storage and feeding device.

### BRIEF DESCRIPTION OF THE DRAWINGS

FIG. 1 is an elevational angled perspective view of the device of the present invention in both the sealed and open configurations.

FIG. 2 is a close-up elevational angled perspective view of a portion of the device of the present invention.

FIG. 3 is a close-up elevational angled perspective view of a portion of the device of the present invention.

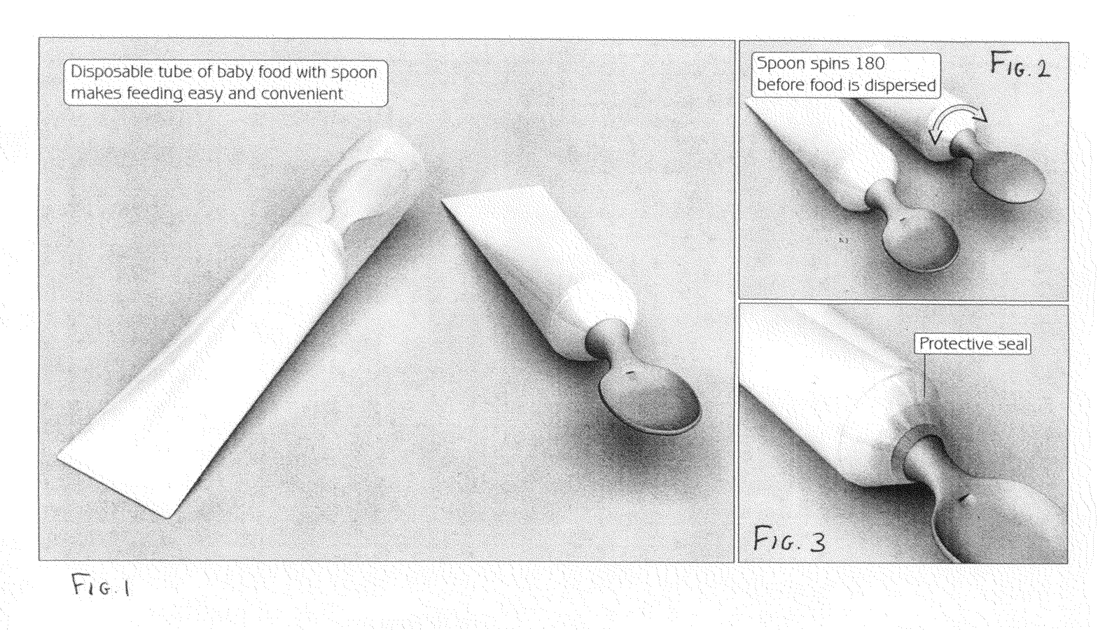

### DETAILED DESCRIPTION OF THE INVENTION

Baby food is any food that is given specifically to infants, roughly between the ages of four months to two years. The food comes in multiple varieties and tastes, can be produced by many manufacturers, or may be table food that the rest of the family is eating, mashed up. A common trait of the many different baby foods is that they are designed for ease of eating; either a soft, liquidy paste or an easily chewed food. This is because infants lack teeth and experience in eating.

Most infants cannot feed themselves until they are over a year old. While hours spent feeding a child can be a special period of bonding for the mother or father and the baby, there are those occasions when feeding a child can be difficult. Specifically, attempting to juggle a bottle in one hand and a jar of food in the other, all while attempting to feed one's infant, can be awkward at best. Further, it is not always possible for the parent to hold their child during mealtimes. Because a child's feeding schedule does not always coordinate with the busy schedule of the parent, many find that taking care of household chores, cooking dinner for the family or even enjoying a few minutes of relaxation, must all be halted when an infant cries to be fed. As much as parents love their children, putting aside an important task or unexpectedly having to stop what one is doing, simply because a baby's feeding schedule is off track, can be a very frustrating experience. Specifically, when the child is strapped in a car seat or seated in a stroller, it can be nearly impossible for the parent to manually feed their child. This problem is of special concern for families who are traveling by car, as pulling off to the side of the road in heavy traffic in order to soothe a crying infant can be a dangerous situation.

The present invention, hereinafter referred as the Baby Food Spoon is a baby food container and a handy spoon, both combined into one convenient unit. The food container itself basically resembles a tube of toothpaste, featuring a malleable plastic material. The food contained within the unit is of the standard baby food variety, with flavors similar to those offered by Gerber's and Beech-Nut. Featuring a safety seal beneath the lid, the threaded opening serves as the attaching point of the provided spoon, a soft plastic utensil with a distinct oval shape. Additionally, a protective cap is provided to enclose the Baby Food Spoon system between uses. Simple in design yet effective in application, one need only choose a container of food, remove the safety seal, and twist on the spoon attachment.

The baby food storage and eating device of the present invention comprises a squeezable tube comprised of a malleable plastic material wherein the tube contains the baby food and having a screw top which has a threaded portion at its first end to engage with the tube and a spoon shaped device at its second end, further having an opening at the base of the bowl of the spoon which engages with the opening of the tube to receive the food when the tube is squeezed.

Squeezing the food container, the user is able to dispense desired amounts of food into the spoon, and feed the waiting baby. Because the health and safety of the infant is of the utmost concern, this product is manufactured in accordance to the stringent guidelines for infant products as set forth by the Juvenile Products Manufactures Association (JPMA).

There are many benefits and advantages associated with the Baby Food Spoon. Foremost, use of the Baby Food Spoon provides parents a practical assist when feeding their infant. Simply by securing a spoon to a jar of food, this unique mechanism provides busy parents an extra hand whenever needed. Perfect for use when juggling a bottle along with jars or serving dishes, the Baby Food Spoon is also utilized to provide a mess-free means of feeding one's infant. Busy Moms and Dads appreciate that this product is especially advantageous in households with more than one small child where attention is often needed by an infant as well as a sibling. Another advantage to the Baby Food Spoon has to do with traveling with an infant. Eliminating the need to juggle jars and spoons separately, the Baby Food Spoon ensures that a child's basic needs are met, without the parent having to pull over their car, simply in order to feed or comfort their child. As this product ultimately follows the strict guidelines set by the JPMA, parents appreciate that the Baby Food Spoon is manufactured with the highest of standards, ensuring the safety and well-being of their child. Although designed for home use, child care professionals also enjoy utilizing this practical invention. In addition, parents of children with disabilities also appreciate the many practical benefits this useful product affords.

The Baby Food Spoon is a unique product invention that offers parents and caregivers a practical and functional accessory for their child. Providing an extra helping hand when feeding an infant, this innovative accessory proves a must-have item in any household with infant and toddler children.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims. Claim:

1. A baby food storage and eating device, comprising:
a baby food container and a handy spoon, combined into one convenient unit comprising a squeezable tube comprised of a malleable plastic material wherein the tube contains the baby food and having a screw top which has a threaded portion at its first end to engage with the tube and a spoon shaped device at its second end, further having an opening at the base of the bowl of the spoon which engages with the opening of the tube to receive the food when the tube is squeezed.

2. The device of claim 1 further comprising a safety seal at the top of the tube, at the top of the threaded opening at the end of the tube.

3. The device of claim 1 further comprising a protective cap to cover the spoon and is frictionally fitted to the top of the tube.

4. The device of claim 1 wherein the rotation of the spoon portion 180 degrees allows the passage of the food from the tube into the spoon.
